(19) United States
(12) Patent Application Publication
(10) Pub. No.: US 2025/0279688 A1
(43) Pub. Date: Sep. 4, 2025

(54) STATOR AND CANNED MOTOR

(71) Applicant: EBARA CORPORATION, Tokyo (JP)

(72) Inventor: Takayuki KURONUMA, Tokyo (JP)

(21) Appl. No.: 18/857,534

(22) PCT Filed: Dec. 12, 2022
(86) PCT No.: PCT/JP2022/045604

§ 371 Date: Oct. 17, 2024

(30) Foreign Application Priority Data
Apr. 28, 2022 (JP) 2022-074248

(51) Int. Cl. H02K 3/487; H02K 1/16; H02K 3/30

(52) U.S. Cl. CPC H02K 3/487; H02K 1/16; H02K 3/30

(57) ABSTRACT

The present application relates to a stator and a canned motor. A stator is provided that includes a stator core, a winding, a potting material, and a spacer that closes a slot opening. The spacer is made of an insulating material and has a linear expansion coefficient lower than that of the potting material.

### TECHNICAL FIELD

The present invention relates to a stator and a canned motor.

### BACKGROUND ART

A stator in which windings are mounted on a stator core is known. As a countermeasure against heat generation, noise, and insulation, in a case, a potting material made of resin is filled into a stator chamber formed in the stator core. In this case, a slot opening formed on an inner circumferential surface of the stator core (i.e., a gap between a plurality of teeth in the stator core) is filled with the potting material.

### CITATION LIST

### Patent Literature

Patent document 1: Japanese laid-open patent publication No. S61-135343
Patent document 2: Japanese laid-open utility model publication No. S52-40908
Patent document 3: Japanese laid-open patent publication No. S52-72402

### SUMMARY OF INVENTION

### Technical Problem

The potting material generally has a large coefficient of linear expansion compared to metals, so the potting material sealed in the stator chamber expands with a temperature rise caused by heat generation from the windings. As a result, there is a risk that the potting material may spill out from the slot opening toward an inner circumference side of the stator.

In a typical motor, a rotor is arranged on the inner circumference side of the stator. Therefore, if the potting material spills out from the slot opening, it may come into contact with the rotor. In a canned motor, a cylindrical can is arranged on the inner circumference side of the stator. Therefore, if the potting material spills out from the slot opening, the can is subjected to the pressing force of the potting material, and as a result, there is a risk that the can may be deformed inward.

Therefore, the present invention provides a stator and a canned motor that can prevent the potting material from spilling out of the slot opening.

### Solution to Problem

In an embodiment, there is provided a stator, comprising: a stator core having a slot opening; a winding attached to the stator core; a potting material sealed in a stator chamber of the stator core; and a spacer configured to close the slot opening, and the spacer is made of an insulating material, and has a linear expansion coefficient lower than that of the potting material.

In an embodiment, the stator comprises a wedge that is adjacent to the spacer and in contact with the winding.

In an embodiment, the spacer and the wedge are integrally formed members, and the spacer extends from the wedge toward the slot opening.

In an embodiment, the spacer is made of a sponge.

In an embodiment, there is provided a canned motor, comprising: a main shaft; a rotor fixed to the main shaft; a can surrounding the rotor; and a stator described above, the stator being in contact with an outer circumferential surface of the can.

In an embodiment, the can and the spacer are integrally formed members.

### Advantageous Effects of Invention

Since the spacer is configured to close the slot opening, it is possible to prevent the potting material from spilling out of the slot opening.

### BRIEF DESCRIPTION OF DRAWINGS

FIG. 1 is a view showing an embodiment of a rotating machine;

FIG. 2 is an enlarged view of the rotating machine shown in FIG. 1;

FIG. 3 is a perspective view showing a spacer assembly;

FIG. 4 is a view showing a can and a spacer that are integrally formed; and

FIG. 5 is a view showing another embodiment of the spacer.

### DESCRIPTION OF EMBODIMENTS

Embodiments of the present invention will be described below with reference to the drawings. In the drawings described below, identical or equivalent components will be marked with the same symbol and redundant explanations will be omitted.

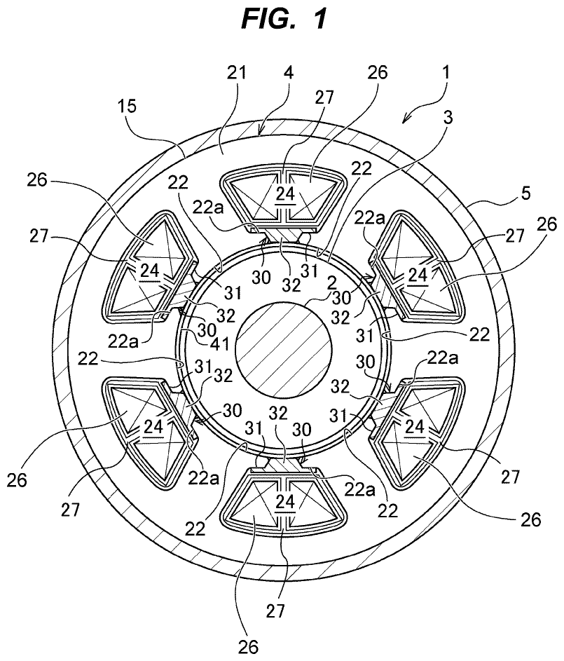

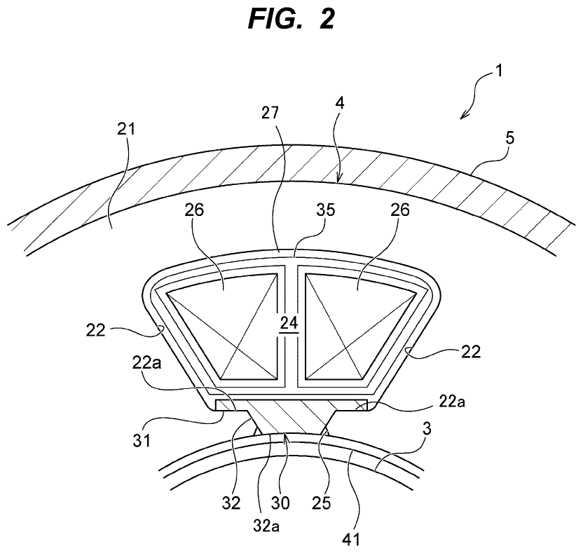

FIG. 1 is a view showing an embodiment of a rotating machine. FIG. 2 is an enlarged view of the rotating machine shown in FIG. 1. As shown in FIG. 1, the rotating machine 1 includes a main shaft 2, a rotor 3 fixed to the main shaft 2, a can 41 surrounding the rotor 3, a stator 4 arranged around the rotor 3 and in contact with an outer circumferential surface of the can 41, and a cylindrical frame 5 arranged around the stator 4. In this embodiment, the rotating machine 1 is a canned motor, but in one embodiment, the rotating machine 1 may be a motor other than a canned motor, or may be a generator.

In one embodiment, the rotating machine 1 may be coupled to a pump that transfers a liquid. Although not shown, the pump includes an impeller, a rotating shaft to which the impeller is fixed, and a pump casing in which the impeller is accommodated. The rotating shaft is coupled to the main shaft 2 of the rotating machine 1, and the rotating shaft and the impeller rotate together with the main shaft 2 by driving the rotating machine 1. Such a combination of the pump and the rotating machine 1 is called a pump apparatus.

The stator 4 is arranged radially inside the frame 5 and is arranged concentrically with the rotor 3. The rotor 3 is rotatably arranged radially inside the stator 4. A gap is formed between the rotor 3 and the stator 4 to allow rotation of the rotor 3, and the can 41 is arranged in this gap.

The rotor 3 is concentric with the main shaft 2 and extends parallel to an axial direction of the main shaft 2. The rotor 3 is rotated by a rotating magnetic field generated in the stator 4, and the main shaft 2 rotates together with the rotor 3.

As shown in FIG. 2, the stator 4 includes a stator core 15 having a slot opening 25, and a plurality of windings (wires) 26 attached to the stator core 15. The stator core 15 includes a cylindrical portion 21 fixed to an inner surface of the frame 5, and a plurality (six in this embodiment) of teeth 22 arranged radially inside the cylindrical portion 21. The cylindrical portion 21 and the teeth 22 are arranged concentrically with the main shaft 2 and the rotor 3. The teeth 22 have wide portions 22a formed at their tip portions, and the slot opening 25 are formed between adjacent the wide portions 22a.

The stator core 15 has a stator chamber 24 formed between adjacent teeth 22, and the stator chamber 24 is connected to the slot opening 25. The windings 26 and an insulating paper 35 (see FIG. 2) are arranged in the stator chamber 24. The stator 4 includes a potting material 27 sealed in the stator chamber 24. The potting material 27 is arranged as a measure against heat generation, noise, and insulation, and is in close contact with the stator core 15 and the windings 26.

As shown in FIGS. 1 and 2, the stator 4 includes a spacer 32 that closes the slot opening 25. The spacer 32 has an inner surface 32a having an arc shape so as to fit along the outer circumferential surface of the can 41 (see FIG. 2), and an inner surface 32a of the spacer 32 is in contact with the can 41. The spacer 32 is made of an insulating material and has a linear expansion coefficient lower than that of the potting material 27.

According to this embodiment, by arranging the spacer 32 at the slot opening 25, the potting material 27 can be removed from the slot opening 25. Therefore, even if the potting material 27 in the stator chamber 24 expands, the potting material 27 is not present at the slot opening 25, and the stator 4 can prevent the potting material 27 from spilling out of the slot opening 25. As a result, it is possible to prevent deformation of the can 41 caused by the pressing force of the potting material 27. Even if the rotating machine 1 does not have a can 41, according to this embodiment, it is possible to prevent the potting material 27 from coming into contact with the rotor 3.

The spacer 32 is affected by the heat generated by the winding 26 and by the expansion of the potting material 27. Therefore, it is desirable for the spacer 32 to have heat resistance and mechanical strength. An example of the spacer 32 is polyphenylene sulfide (PPS) resin, which is an example of a thermoplastic resin (or a thermosetting resin).

In the embodiments shown in FIGS. 1 and 2, the stator 4 includes a wedge 31 that is adjacent to the spacer 32 and maintains a position of the winding 26. The wedge 31 has an insulating function and is in contact with the winding 26. The spacer 32 and the wedge 31 are integrally formed members, and a combination of the spacer 32 and the wedge 31 is a spacer assembly 30. In one embodiment, depending on a configuration of the stator 4, the stator 4 may not include the wedge 31. For example, when the winding 26 is wound around a bobbin made of an insulating material such as resin, the stator 4 may not include the wedge 31.

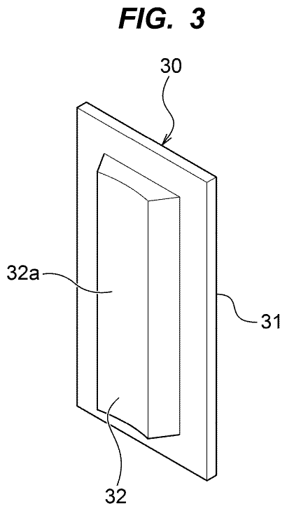

FIG. 3 is a perspective view showing the spacer assembly. As shown in FIG. 3, the wedge 31 has a plate shape that can be supported by the wide portion 22a of the each of teeth 22, and the spacer 32 extends in a convex shape from the wedge 31 toward the slot opening 25. The wedge 31 has a rectangular shape extending in a lamination direction of the stator core 15, and the spacer 32 also has a rectangular shape like the wedge 31.

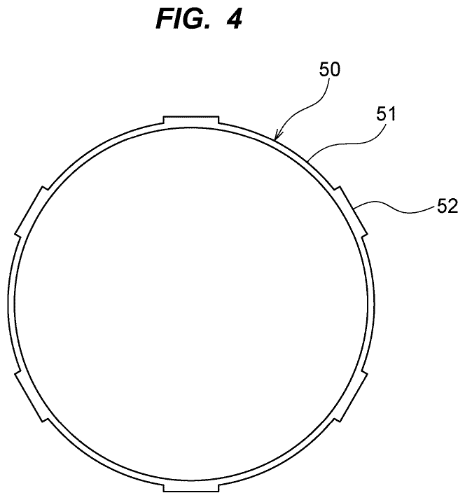

FIG. 4 is a view showing a can and a spacer that are integrally formed. As shown in FIG. 4, the rotating machine 1 as the canned motor may include a can 51 and a spacer 52 that are integrally formed with each other. A combination of the can 51 and the spacer 52 is a spacer assembly 50. The spacer assembly 50 includes a spacer 52 that extends outwardly in a convex shape from an outer circumferential surface of the cylindrical can 51. When the spacer assembly 50 is attached to the stator 4, the spacer 52 is configured to close the slot opening 25. The can 51 and the spacer 52 are integrally molded members and are manufactured by a method such as resin molding, for example.

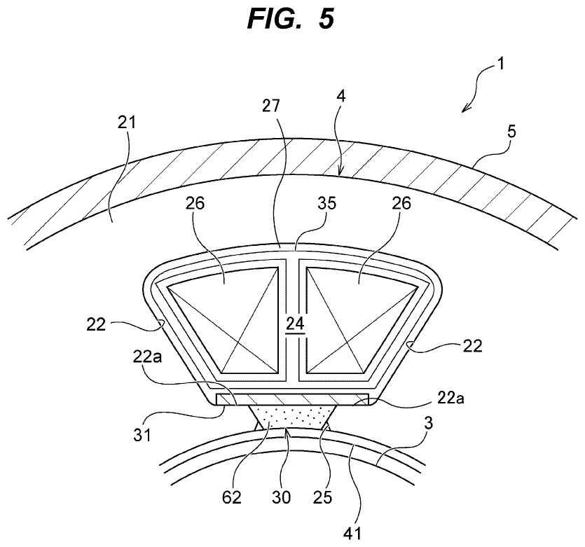

FIG. 5 is a view showing another embodiment of the spacer. In this embodiment, the same components as those in the above-described embodiment are denoted by the same reference numerals, and detailed description thereof will be omitted. As shown in FIG. 5, the stator 4 may include a spacer 62 made of a sponge. In this embodiment, the sponge-like spacer 62 is formed of a separate member from the wedge 31. In one embodiment, the stator 4 may have a structure including only the spacer 62 without including the wedge 31.

A heat-resistant sponge made of silicone can be given as an example of the spacer 62. The spacer 62 has a flexible shape and is inserted into the slot opening 25. The spacer 62 inserted into the slot opening 25 can prevent the potting material 27 from entering the slot opening 25 and can absorb the expansion of the potting material 27.

Although the embodiment of the present invention has been described above, the present invention is not limited to the above-mentioned embodiment, and it is needless to say that the present invention may be embodied in various different forms within the scope of the technical concept thereof.

### INDUSTRIAL APPLICABILITY

The present invention is applicable to a stator and a canned motor.

### REFERENCE SIGNS LIST

1 rotating machine
2 main shaft
3 rotor
4 stator
5 frame
15 stator core
21 cylindrical portion
22 teeth
22a wide portion
24 stator chamber
25 slot opening
26 winding
27 potting material
30 spacer assembly
31 wedge
32 spacer
32a inner surface
35 insulating paper
41 can
50 spacer assembly
51 can
52 spacer
62 spacer

What is claimed is:

1. A stator, comprising:
a stator core having a slot opening;
a winding attached to the stator core;
a potting material sealed in a stator chamber of the stator core; and
a spacer configured to close the slot opening, and
wherein the spacer is made of an insulating material, and has a linear expansion coefficient lower than that of the potting material.

2. The stator according to claim 1, wherein the stator comprises a wedge that is adjacent to the spacer and in contact with the winding.

3. The stator according to claim 2, wherein the spacer and the wedge are integrally formed members, and
wherein the spacer extends from the wedge toward the slot opening.

4. The stator according to claim 1, wherein the spacer is made of a sponge.

5. A canned motor, comprising:
a main shaft;
a rotor fixed to the main shaft;
a can surrounding the rotor; and
a stator according to claim 1, the stator being in contact with an outer circumferential surface of the can.

6. The canned motor according to claim 5, wherein the can and the spacer are integrally formed members.
